(19) United States
(12) Patent Application Publication
(10) Pub. No.: US 2007/0058069 A1
(43) Pub. Date: Mar. 15, 2007

(54) Packaging structure of a light sensation module

(76) Inventors: Po-Hung Chen, Chu-Tung (TW); Mao-Jung Chen, Chu-Tung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,114

(22) Filed: Sep. 14, 2005

(51) Int. Cl. H04N 5/225; G02B 7/02

(52) U.S. Cl. 348/340; 359/811

(57) ABSTRACT

A packaging structure of a light sensation module includes a substrate, a light sensation chip, a housing and a lens barrel. The light sensation chip is installed on the substrate and is electrically connected to the substrate. The lens barrel is movably installed to the housing, and the corresponding surfaces of the housing and the lens barrel are smooth. Thereby, the pollutants brought about by friction can be reduced; the deposition of external pollutants can be avoided; the yield can be promoted; and the cost can be lowered.

### BACKGROUND OF THE INVENTION

1. Field of the Invention

The present invention relates to a packaging structure of a light sensation module, particularly to a packaging structure of a light sensation module, which can promote the yield.

2. Description of the Related Art

Refer to FIG. 1. In a conventional packaging structure of a light sensation module, a substrate 10 has multiple metallization traces 11; a light sensation chip 20 is fixed on the substrate 10, and via a wire-bonding method, the metallization traces 11 are used to electrically interconnect the light sensation chip 20 and the substrate 10; an injection-molded housing 30 is installed to the substrate 10 and covers the light sensation chip 20; the internal surface of the housing 30 has internal screw threads 31, which mate with the corresponding external screw threads 41 of a lens barrel 40; the lens barrel 40 has an aperture 42, an aspherical lens 43 and an IR-cut filter 44, and the lens barrel 40 transmits light to the light sensation chip 20 to form an image.

In this conventional packaging structure of a light sensation module, there is an interface existing between the internal screw threads 31 of the housing 30 and the external screw threads 41 of the lens barrel 40. Rotating the screw can adjust the relative positions of the lens barrel 40 and the housing 30, and fix them. However, such an interface is apt to get external pollutants, e.g. particles, via the friction therebetween; the external pollutants are likely to accumulate in the recessed nooks of the interface between the internal screw threads 31 and the external threads 41 and hard to clean. Thus, the yield of the fabrication process and the quality of the products will be influenced.

### SUMMARY OF THE INVENTION

The primary objective of the present invention is to provide a packaging structure of a light sensation module to overcome the aforementioned problems of the conventional technology, wherein the lens barrel is installed into the housing without using any screw thread, and the probability that the packaging structure is polluted by particles in tuning light focus process is reduced, and the yield is promoted.

To achieve the aforementioned objective, the packaging structure of a light sensation module of the present invention comprises: a substrate, a light sensation chip, a housing and a lens barrel. The light sensation chip is installed on the substrate. Via multiple metallization traces on the surfaces of the substrate, the light sensation chip is electrically connected to the substrate. A lens and an aperture are installed along the central line surfaces of the substrate, the light sensation chip is electrically connected to the substrate. A lens and an aperture are installed along the central line of the lens barrel, and the lens can receive light via the aperture. The housing has two hollow ends and is disposed above the substrate and covers the light sensation chip. The lens barrel is movably sleeved inside the housing. The housing can protect the lens barrel, and can guide or complement the lens barrel to adjust the relative position between the lens barrel and the light sensation chip so that light can be focused on the light sensation chip. The external surface of the lens barrel and the corresponding internal surface of the housing are smooth, which can avoid the deposition of external pollutants, which are hard to clean, during the fabrication process; thus, the yield can be promoted.

To enable the objectives, characteristics, functions of the present invention to be more easily understood, the present invention is to be described below in detail in cooperation with the attached drawings.

### BRIEF DESCRIPTION OF THE DRAWINGS

FIG. 1 is a schematic diagram of a conventional packaging structure of a light sensation module.

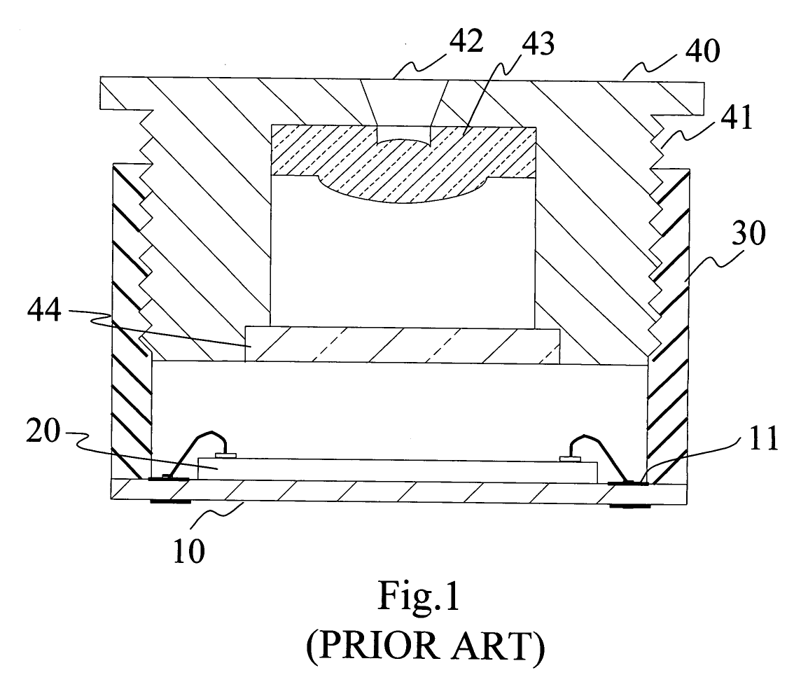

FIG. 2 is a schematic diagram of the packaging structure of a light sensation module according to one embodiment of the present invention.

FIG. 3 is a schematic diagram showing that conductors are used to electrically interconnect the metallization traces in the packaging structure of a light sensation module according to one embodiment of the present invention.

FIG. 4 is a schematic diagram showing that the electroplated through-holes of the substrate are used to electrically interconnect the metallization traces in the packaging structure of a light sensation module according to one embodiment of the present invention.

### DETAILED DESCRIPTION OF THE INVENTION

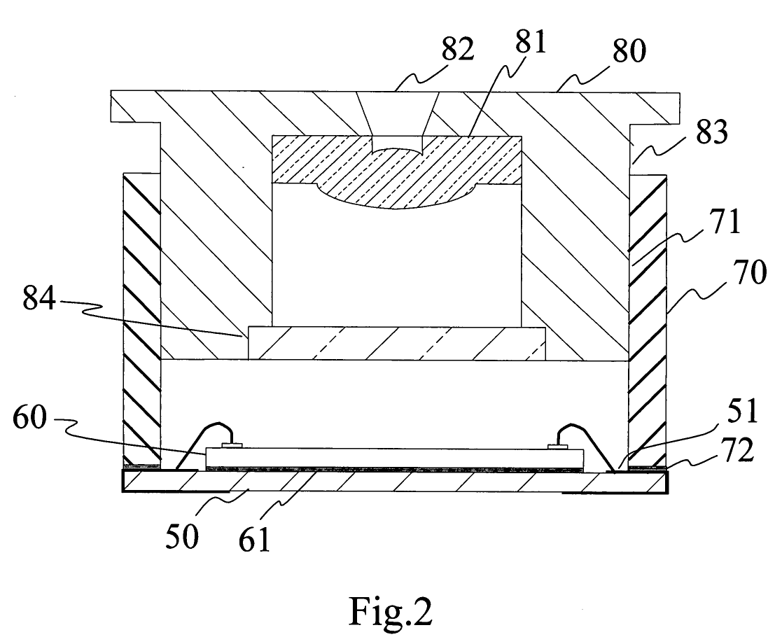

Referring to FIG. 2, the packaging structure of a light sensation module according to one embodiment of the present invention comprises: a substrate 50, a light sensation chip 60, a housing 70 and a lens barrel 80. Multiple metallization traces 51 are disposed on the top and bottom surfaces of the substrate 50. The light sensation chip 60 is installed on the substrate 50, and via a wire-bonding method, the metallization traces 51 are used to electrically connect the light sensation chip 60 with the substrate 50. The lens barrel 80 has a lens 81 and an aperture 82. The aperture 82 penetrates the front end of the lens barrel 80 and functions as a light entrance. The lens 81 receives light via the aperture 81 and focuses the light onto the light sensation chip 60. The housing 70 has two hollow ends and is disposed above the substrate 50 and covers the light sensation chip 60. The lens barrel 80 is movably sleeved inside the housing 70. The housing 70 can protect the lens barrel 80, and can guide or complement the lens barrel 80 to change the relative position between the lens barrel 80 and the light sensation chip 60 and to adjust the distance between the lens barrel 80 and the light sensation chip 60 so that the light imaging effect on the light sensation chip 60 can be modified. Herein, the lens barrel 80 is of a cylindrical shape; the external surface of the lens barrel 80 and the corresponding internal surface of the housing 70 are smooth, which can reduce the probability that external pollutants accumulate thereon. From the section views thereof, the edges 71, 83 of them are continuous, in contrast with the sharp angles and recesses of the screw in the abovementioned prior art; therefore, the deposition probability of external pollutants can be reduced. In addition to the cylindrical shape, the lens barrel may also be of another cone shape, such as a tetragonal pyramid or a trigonal pyramid.

In this embodiment, the aperture 82 in the front end of the lens barrel 80 is disposed at the central line of the lens barrel 80 so that light can be distributed symmetrically on the light sensation chip 60. The bottom end of the lens barrel 80 may has a light-permeable layer 84, which allows some light to pass through or filters the light of a specific wavelength; for example, the light-permeable layer 84 may be an IR-cut filter, which can filter out a far-infrared ray.

Further, in this embodiment, the light sensation chip 60 can be stuck onto the substrate 50 with a glue layer 61, and the glue layer 61 may be a silver epoxy glue or an adhesive tape. Furthermore, the housing 70 can also be stuck onto the substrate 50 with an adhesive layer 72.

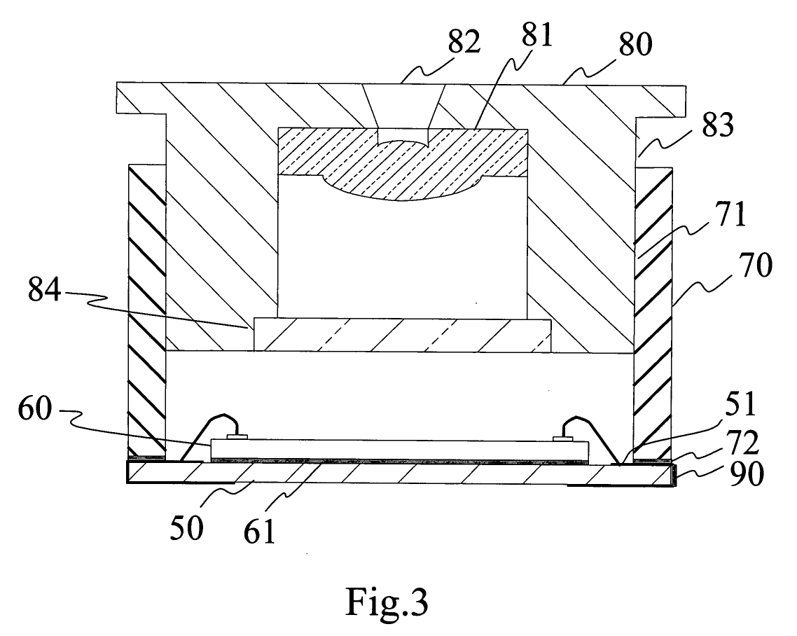

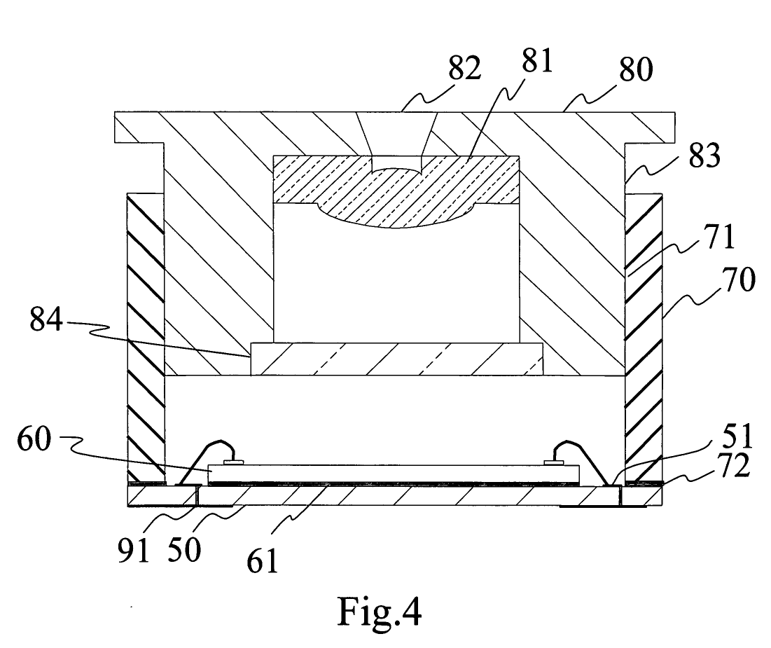

In this embodiment, the metallization traces 51 are disposed along the perimeter of the substrate 50 and on both the top and the bottom surfaces of the substrate 50. In practice, only if the light sensation chip 60 can be electrically connected to the exterior of the substrate 60, the metallization traces can be disposed on the top surface or the bottom surface or both the top and the bottom surfaces of the substrate 50. Thus, as shown in FIG. 3, the metallization traces on the lateral sides of the substrate 50 can be replaced by a plurality of conductors 90, which can interconnect the wirings 51 on the top surface and the bottom surface of the substrate 50; otherwise, as shown in FIG. 4, electroplated through-holes 91 can also be used as conductors to electrically interconnect the wirings 51 on the top surface and the bottom surface of the substrate 50; those two methods can obtain the same effect.

Those embodiments disclosed above are only to clarify the present invention and not intended to limit the scope of the present invention. Any equivalent modification and variation according to the spirit of the present invention is to be included within the scope of the present invention, and the claims stated below are to be referred to for the scope of the present invention.

What is claimed is:

1. A packaging structure of a light sensation module, comprising:
a substrate, having multiple metallization traces on its surfaces;
a light sensation chip, installed to said substrate, and electrically connected to said metallization traces on said substrate;
a housing, being a hollow body with two hollow ends, and having a smooth internal surface, and installed to said substrate, and covering said light sensation chip; and
a lens barrel, having a cylindrical shape and a smooth external surface, and movably sleeved inside said housing for performing a displacement with respect to said light sensation chip, and further comprising at least one aperture and at least one lens, wherein light can pass through said aperture and then is received by said lens.

2. The packaging structure of a light sensation module according to claim 1, further comprising a light-permeable layer, which is installed to the bottom end of said lens barrel and allows light to pass through.

3. The packaging structure of a light sensation module according to claim 2, wherein said light-permeable layer can filter out the light of a specific wavelength.

4. The packaging structure of a light sensation module according to claim 3, wherein said light-permeable layer can filter out a far-infrared ray.

5. The packaging structure of a light sensation module according to claim 1, wherein said aperture is positioned at the central line of said lens barrel to enable light to be symmetrically distributed on said light sensation chip.

6. The packaging structure of a light sensation module according to claim 1, wherein said light sensation chip is stuck onto said substrate with a glue layer.

7. The packaging structure of a light sensation module according to claim 6, wherein said glue layer is a silver epoxy glue or an adhesive tape.

8. The packaging structure of a light sensation module according to claim 1, wherein said housing is stuck to said substrate with an adhesive layer.

9. The packaging structure of a light sensation module according to claim 1, wherein said metallization traces is disposed on the top surface of said substrate, or the bottom surface of said substrate, or the top and the bottom surfaces of said substrate.

10. The packaging structure of a light sensation module according to claim 9, wherein a plurality of conductors are used to electrically interconnect said metallization traces on the top surface and the bottom surface of said substrate.

11. The packaging structure of a light sensation module according to claim 9, wherein said conductors are disposed along the perimeter of said substrate.

12. The packaging structure of a light sensation module according to claim 9, wherein said conductors are electroplated through-holes.

13. The packaging structure of a light sensation module according to claim 12, wherein said through-holes penetrate said substrate.

14. The packaging structure of a light sensation module according to claim 1, wherein said light sensation chip is electrically connected to said substrate via a wire-bonding method.
